(19) United States
(12) Patent Application Publication
(10) Pub. No.: US 2025/0357048 A1
(43) Pub. Date: Nov. 20, 2025

(54) MULTILAYER CERAMIC CAPACITOR

(71) Applicant: Murata Manufacturing Co., Ltd., Nagaokakyo-shi (JP)

(72) Inventors: Tatsunori YASUDA, Nagaokakyo-shi (JP); Shinichi HIKIDA, Nagaokakyo-shi (JP)

(21) Appl. No.: 19/281,798

(22) Filed: Jul. 28, 2025

Related U.S. Application Data
(63) Continuation of application No. PCT/JP2024/000838, filed on Jan. 15, 2024.

(30) Foreign Application Priority Data
Feb. 1, 2023 (JP) 2023-014099

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic capacitor includes a laminate including an inner layer portion and two outer layer portions, and outer electrodes on end surfaces on two sides in a length direction of the laminate and connected to the inner electrode layer. When one of the two outer layer portions is divided into three equal or substantially equal portions in the layering direction, a porosity S1 of an outermost layer positioned on the main surface side, a porosity S2 of a middle layer, and a porosity S3 of an innermost layer positioned on the inner layer portion side satisfy S1>S2>S3.

### CROSS REFERENCE TO RELATED APPLICATIONS

This application claims the benefit of priority to Japanese Patent Application No. 2023-014099 filed on Feb. 1, 2023 and is a Continuation application of PCT Application No. PCT/JP2024/000838 filed on Jan. 15, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

The demand for a decrease in size and an increase in capacitance of electronic components including multilayer ceramic capacitors and the like has risen along with the miniaturization and high performance of electronic devices such as mobile phones and digital devices.

A multilayer ceramic capacitor included in a mobile device such as a mobile phone and a portable music player needs to be configured such that it is not detached from the mounting board or cracked even when subjected to an impact due to falling or other factors.

Furthermore, a multilayer ceramic capacitor included in in-vehicle equipment such as an ECU needs to be configured such that it is not cracked even when receiving a bending stress generated by linear expansion or contraction of the mounting board in a thermal cycle or even when receiving a tensile stress applied to the external electrodes.

In general, a multilayer ceramic capacitor includes a multilayer body including a stack of dielectric layers and internal electrode layers that are alternately laminated, and additional dielectric layers laminated on an upper surface and a lower surface of the stack, and a pair of external electrodes formed on opposite end surfaces of the multilayer body. There is a known technique for increasing the mechanical strength of a multilayer ceramic capacitor by forming, between a base electrode layer and a plating layer of the external electrodes, a conductive resin layer of a paste including a thermoplastic resin, a metal element, and a glass component. This technique makes it possible to relax mechanical and thermal stresses that the multilayer body receives from a wiring board on which the multilayer ceramic capacitor is mounted (see, e.g., Japanese Unexamined Patent Application, Publication No. 2019-16781).

However, disposing such a conductive resin layer increases the thickness of the external electrode, and therefore, is likely to lead to an increase in the size of the multilayer ceramic capacitor. The technique of forming the conductive resin layer cannot be said to be sufficient for multilayer ceramic capacitors which should be further reduced in size and further increased in capacitance in the future.

Therefore, there is a demand to develop a multilayer ceramic capacitor that has a high mechanical strength while allowing for a reduction in size and an increase in capacitance.

### SUMMARY OF THE INVENTION

Example embodiments of the present invention provide multilayer ceramic capacitors that each have a high mechanical strength and a reduced size and an increased capacitance.

The inventors of example embodiments of the present invention discovered that in a multilayer ceramic capacitor including outer layer portions sandwiching an inner layer portion in which dielectric layers and internal electrode layers are alternately laminated in a lamination direction, configuring the outer layer portion such that a porosity S1 of an outermost layer adjacent to a main surface, a porosity S2 of an intermediate layer, and a porosity S3 of an innermost layer adjacent to the inner layer portion satisfy a predetermined relationship makes it possible to relax mechanical and thermal stresses that the multilayer ceramic capacitor receives from a wiring board on which the multilayer ceramic capacitor is mounted.

According to an example embodiment of the present invention, a multilayer ceramic capacitor includes a multilayer body including an inner layer portion and two outer layer portions, the inner layer portion including dielectric layers and internal electrode layers alternately laminated in a lamination direction, the two outer layer portions sandwiching the inner layer portion in the lamination direction and defining two main surfaces at positions opposite to each other in the lamination direction, and an external electrode on each of end surfaces of the multilayer body opposed to each other in a length direction intersecting with the lamination direction, the external electrode being connected to the internal electrode layers. In the multilayer ceramic capacitor, in a case where one of the two outer layer portions sandwiching the inner layer portion is divided, in the lamination direction, into three equal or substantially equal layers including an outermost layer located adjacent to the main surface and having a porosity S1, an intermediate layer having a porosity S2, and an innermost layer located adjacent to the inner layer portion and having a porosity S3, the porosities S1, S2, and S3 satisfy S1>S2>S3.

Example embodiments of the present invention provide multilayer ceramic capacitors each with relaxed mechanical and thermal stresses that the multilayer ceramic capacitor receives from a wiring board on which the multilayer ceramic capacitor is mounted, while enabling a reduction in size and an increase in capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor 1 according to a first example embodiment of the present invention.

FIG. 2 is a cross-sectional view of the multilayer ceramic capacitor 1 taken along line II-II in FIG. 1.

FIG. 3 is a cross-sectional view of the multilayer ceramic capacitor 1 taken along line III-III in FIG. 1.

FIG. 4 is a schematic view illustrating a structure of an inner layer portion 6 of the multilayer ceramic capacitor 1.

FIG. 5 is a cross-sectional view of the multilayer ceramic capacitor 1 taken along line III-III in FIG. 1, and illustrates another form of a side gap portion.

FIG. 6 is an external perspective view of a multilayer ceramic capacitor 100 according to a second example embodiment of the present invention.

FIG. 7 is a cross-sectional view of the multilayer ceramic capacitor 100 taken along line VII-VII in FIG. 6.

FIG. 8 is a schematic view illustrating a structure of an inner layer portion 6 of the multilayer ceramic capacitor 100.

FIG. 9 is an external perspective view of a multilayer ceramic capacitor 200 according to a third example embodiment of the present invention.

FIG. 10 is a cross-sectional view of the multilayer ceramic capacitor 200 taken along line X-X in FIG. 9.

FIG. 11 is a schematic view illustrating a structure of an inner layer portion 6 of the multilayer ceramic capacitor 200.

### DETAILED DESCRIPTION OF THE EXAMPLE EMBODIMENTS

Example embodiments relating to the multilayer ceramic capacitor of the present invention will be described in detail below with reference to the drawings.

The following example embodiments are each described as being illustrative of the present invention, and the present invention is not limited to the features of the following example embodiments.

Furthermore, it is possible to combine features of different ones of the following example embodiments, and such combinations are also encompassed in the scope of the present invention.

The drawings are to facilitate understanding of the specification and may schematically depict components. The ratio between the dimensions of the depicted components may be different from that described in the specification.

In addition, some of the components described in the specification may not be illustrated in the drawings or may be illustrated in a reduced number.

### First Example Embodiment

### Multilayer Ceramic Capacitor

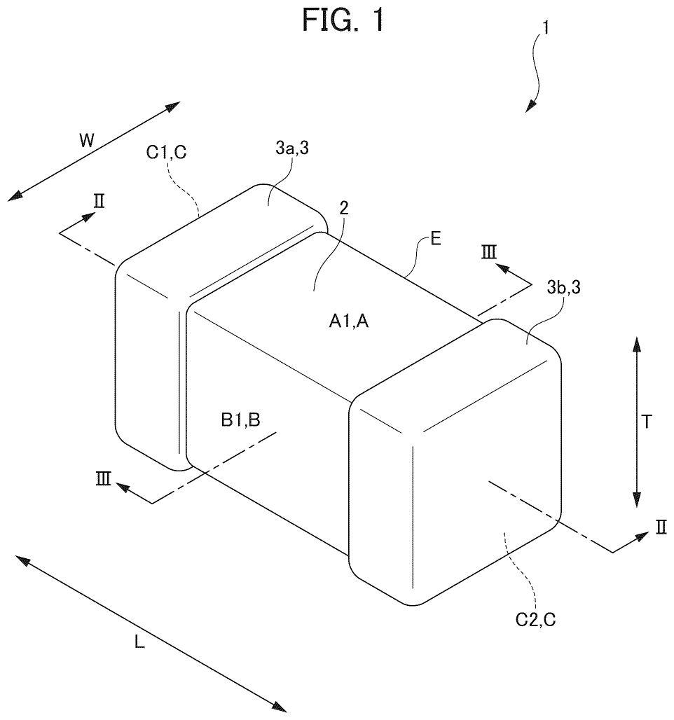

FIGS. 1 to 5 illustrate the shape and structure of a multilayer ceramic capacitor 1 according to a first example embodiment of the present invention.

FIG. 1 is a schematic perspective view of the multilayer ceramic capacitor 1.

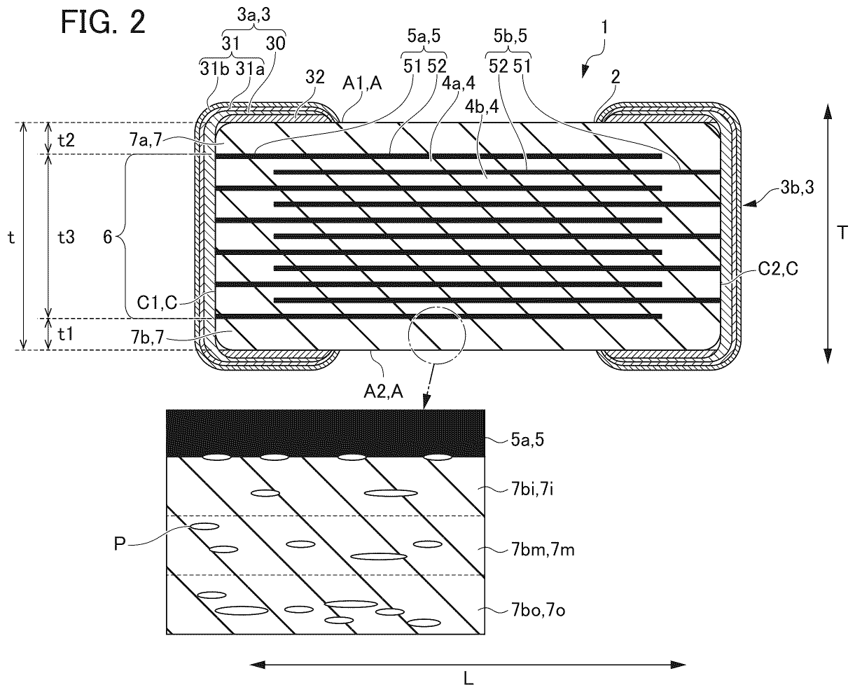

FIG. 2 is a cross-sectional view (LT cross-sectional view) of the multilayer ceramic capacitor 1 taken along the line II-II extending through a central portion in the width direction W shown in FIG. 1.

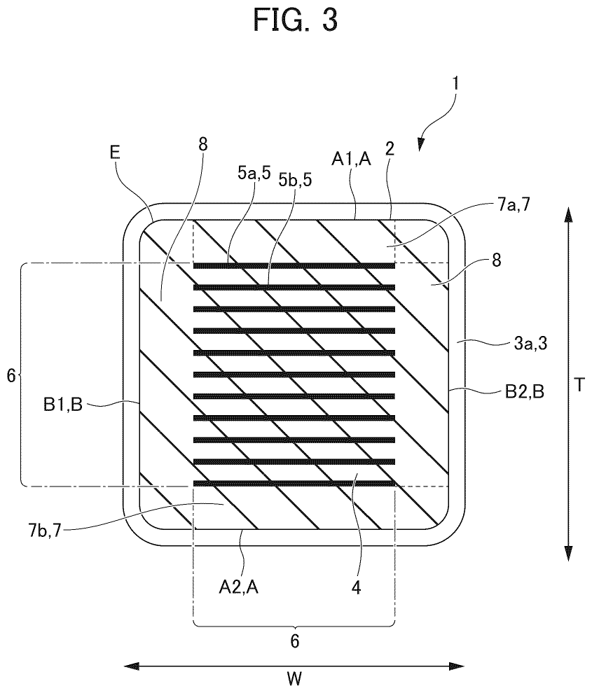

FIG. 3 is a cross-sectional view (WT cross-sectional view) of the multilayer ceramic capacitor 1 taken along the line III-III extending through a central portion in the length direction L shown in FIG. 1.

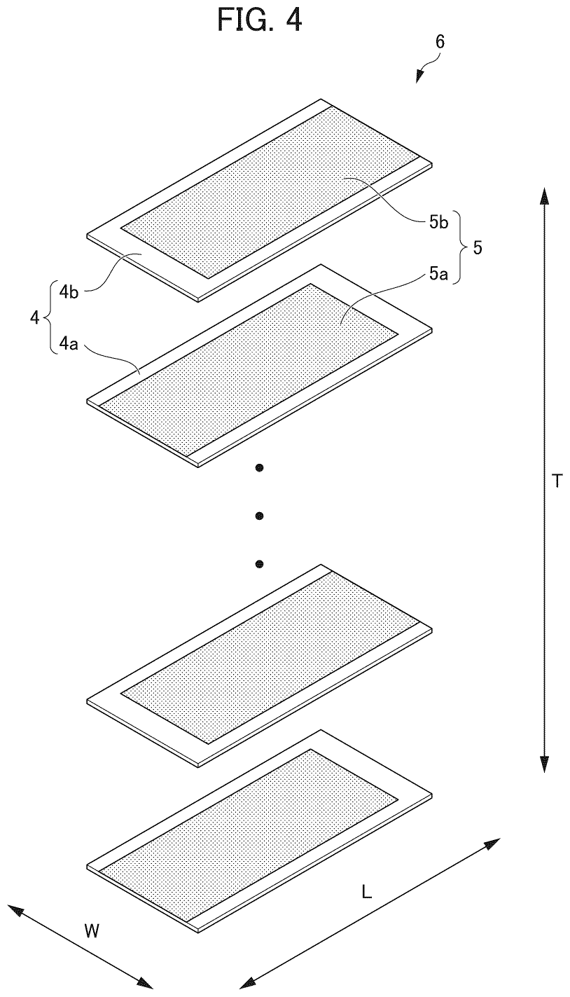

FIG. 4 is a schematic view illustrating a structure of an inner layer portion 6 of the multilayer ceramic capacitor 1.

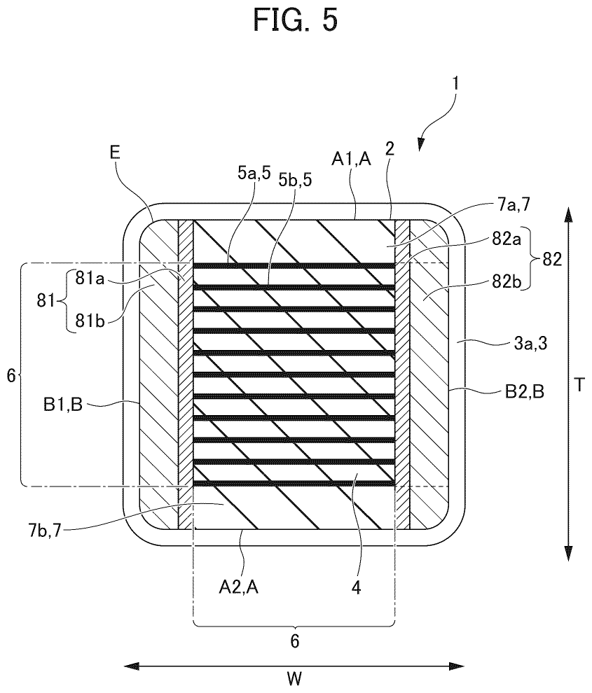

FIG. 5 is a cross-sectional view (WT cross-sectional view) of the multilayer ceramic capacitor 1 taken along the line III-III extending through the central portion in the length direction L shown in FIG. 1, and illustrates side gap portions different from the side gap portions illustrated in FIG. 3.

The structure of the multilayer ceramic capacitor 1 will be described with reference to a lamination direction T in which dielectric layers 4 and internal electrode layers 5 are laminated, a length direction L orthogonal or substantially orthogonal to the lamination direction T, and a width direction W orthogonal or substantially orthogonal to the lamination direction T and the length direction L.

Although the lamination direction T, the width direction W, and the length direction L, are orthogonal or substantially orthogonal to each other in the following example embodiments, these directions are not necessarily orthogonal or substantially orthogonal to each other and may intersect with each other.

The multilayer ceramic capacitor 1 has a rectangular or substantially rectangular parallelepiped shape and includes a multilayer body 2 and a pair of external electrodes 3 provided on opposite ends of the multilayer body 2.

The multilayer body 2 includes an inner layer portion 6 that includes a plurality of sets of a dielectric layer 4 and an internal electrode layer 5.

The multilayer body 2 includes six outer surfaces, among which a pair of outer surfaces opposite to each other in the lamination direction T is defined as a first main surface A1 and a second main surface A2, a pair of outer surfaces opposite to each other in the width direction W is defined as a first side surface B1 and a second side surface B2, and a pair of outer surfaces opposite to each other in the length direction L is defined as a first end surface C1 and a second end surface C2.

The first main surface A1 and the second main surface A2 are collectively referred to as a main surface(s) A when it is unnecessary to particularly distinguish from each other. The first side surface B1 and the second side surface B2 are collectively referred to as a side surface(s) B when it is unnecessary to particularly distinguish from each other. The first end surface C1 and the second end surface C2 are collectively referred to as an end surface(s) C when it is unnecessary to particularly distinguish from each other.

Although the multilayer ceramic capacitor 1 may have any dimensions without particular limitation, the dimension in the lamination direction T may be about 0.1 mm or more and about 6.5 mm or less, the dimension in the length direction L may be about 0.2 mm or more and about 6.5 mm or less, and the dimension in the width direction W may be about 0.1 mm or more and about 5.5 mm or less, for example.

### Multilayer Body

The multilayer body 2 includes the inner layer portion 6, outer layer portions 7 disposed on sides of the inner layer portion 6 that are adjacent to the main surfaces A, and side gap portions 8 disposed on sides of the inner layer portion 6 that are adjacent to the side surfaces B.

Preferably, the multilayer body 2 has rounded ridge portion E.

Each ridge portion E is where two of the surfaces of the multilayer body 2, namely, the main surface A and the side surface B, the main surface A and the end surface C, or the side surface B and the end surface C, meet each other. Each ridge portion E includes a corner portion where the main surface A, the side surface B, and the end surface C meet each other.

### Inner Layer Portion

The inner layer portion 6 is located between the internal electrode layer 5 closest to the first main surface A1 and the internal electrode layer 5 closest to the second main surface A2, both inclusive, and is a portion where the plurality of internal electrode layers 5 face each other with the dielectric layer 4 interposed therebetween to form a capacitance.

FIG. 4 schematically illustrates the structure of the inner layer portion 6.

In an actual multilayer ceramic capacitor, the dielectric layers 4 are integrated so that boundaries therebetween cannot be visually perceived.

### Internal Electrode Layer

Each internal electrode layer 5 may have any shape without particularly limitation, but preferably has a rectangular or substantially rectangular shape.

The corner portions of the rectangular or substantially rectangular shape may be rounded, or may have an oblique shape.

First internal electrode layers 5a extend toward the first end surface C1 of the multilayer body 2, and second internal electrode layers 5b extend toward the second end surface C2 of the multilayer body 2.

The internal electrode layers 5 are formed by sintering, on the dielectric layers 4, a conductive paste including a metal powder that defines and functions as a conductor, an organic solvent, a binder, and a dispersant.

The internal electrode layers 5 and the dielectric layers 4 are alternately laminated to define the inner layer portion 6.

The internal electrode layers 5 include the first internal electrode layers 5a and the second internal electrode layers 5b, and each first internal electrode layer 5a and each second internal electrode layer 5b are disposed on the dielectric layers 4a and 4b, respectively.

The first internal electrode layers 5a and the second internal electrode layers 5b are collectively referred to as the internal electrode layer(s) 5 when it is unnecessary to particularly distinguish from each other.

Examples of a conductive material of the internal electrode layers 5 include, but are not limited to, a metal such as Ni, Cu, Ag, Pd, or Au, a Ag—Pd alloy, or an alloy including at least one of the forgoing metals.

Each internal electrode layer 5 may have any thickness without particular limitation, and the thickness may be, for example, from about 0.3 μm to about 1.5 μm.

Each internal electrode layer 5 includes a counter electrode portion 52 and an extension electrode portion 51 extending from the counter electrode portion 52 toward one of the end surfaces C. The first internal electrode layer 5a and the second internal electrode layer 5b face each other at their counter electrode portions 52 and not at their extension electrode portions 51.

An end portion of each extension electrode portion 51 is exposed at the end surface C and is electrically connected to the external electrode 3.

The direction in which the extension electrode portions 51 of the first internal electrode layers 5a extend is different from the direction in which the extension electrode portions 51 of the second internal electrode layers 5b extend. The extension electrode portions 51 of the first internal electrode layers 5a and those of the second internal electrode layers 5b extend toward the first end surface C1 and the second end surface C2 in an alternating manner.

Charges are accumulated between the counter electrode portions 52 of the first internal electrode layer 5a and the second internal electrode layer 5b adjacent to each other in the lamination direction T, such that the function as the capacitor is provided.

Each of the first internal electrode layers 5a and the second internal electrode layers 5b preferably has a thickness of about 0.2 μm or more and about 2.0 μm or less, for example.

It is preferable that the total number of the first internal electrode layers 5a and the second internal electrode layers 5b is, for example, 2 or more and 2000 or less.

### Dielectric Layer

The dielectric layers 4 can be made of, for example, a ceramic material as a dielectric material.

Examples of the ceramic material include BaTiO₃, CaTio₃, SrTiO₃, CaZro₃, or the like.

In a case where the dielectric material is used as a main component, subcomponents such as, for example, a Si compound, a Mg compound, an Al compound, a Mn compound, a Sn compound, a Cu compound, a Ni compound, or a rare earth compound may be added in accordance with desired characteristics of the multilayer body.

In the case of using BaTiO₃ or the like as the main component of the dielectric layers 4, crystal grains having a perovskite structure are provided in the dielectric layers 4.

In order to increase the capacitance of the multilayer ceramic capacitor, it is preferable that the crystal grains have a diameter of, for example, about 1 μm or less and the dielectric layers have a small thickness.

Each dielectric layer 4 includes, for example, a sintered body of a ceramic green sheet including the ceramic material.

Each dielectric layer 4 may have any thickness without particular limitation, and the thickness may be, for example, from about 0.2 μm to about 10.0 μm in an effective region for forming capacitance, which includes the first internal electrode layers 5a and the second internal electrode layers 5b.

The number of the dielectric layers 4 is not particularly limited, and may be, for example, 2 to 2000 in the effective region for forming capacitance, which includes the first internal electrode layers 5a and the second internal electrode layers 5b.

### Outer Layer Portion

The outer layer portions 7 are disposed on the upper and lower sides of the inner layer portion 6, respectively. Each outer layer portion includes only a dielectric layer and excludes the internal electrode layer 5.

Each outer layer portion 7 may have any thickness without particular limitation, and the thickness may be, for example, about 15 μm to about 150 μm.

The outer layer portions 7 are made of a ceramic material, which may be the same as the material forming the dielectric layers 4 in the inner layer portion 6.

The dielectric layer in each outer layer portion 7 may be thicker than the dielectric layer in the effective region for forming capacitance, in which the internal electrode layers 5 are arranged.

The material of the dielectric layer in each outer layer portion 7 may be different from the material forming the dielectric layers 4 in the inner layer portion 6.

### Side Gap Portion

The side gap portions 8 are provided in the multilayer body 2 and extend on sides of the inner layer portion 6 that are adjacent to the side surfaces B.

The dimension of each side gap portion 8 in the width direction W is, for example, preferably about 5 μm or more and about 40 μm or less, and particularly preferably about 5 μm or more and about 20 μm or less.

The side gap portions 8 can be provided integrally with the inner layer portion 6 using the same material as that of the dielectric layers 4. Alternatively, the side gap portions 8 may be formed by attaching the same ceramic material as that of the dielectric layers 4 to both side surfaces of the inner layer portion 6 in the width direction W.

The side gap portions 8 are also referred to as W gap portions.

FIG. 5 illustrates an example in which side gap portions 81 and 82 are formed by attaching a ceramic material to both side surfaces of the inner layer portion 6 in the width direction W.

Each of the side gap portions 81 and 82 may have a two-layer structure including an inner layer 81a or 82a disposed inward in the width direction W and an outer layer 81b or 82b disposed outward in the width direction W.

The boundary between the inner layer 81a or 82a and the outer layer 81b or 82b can be easily ascertained by observation using, for example, an optical microscope because there is a difference in degree of sintering between the inner and outer layers.

The side gap portions 8 are not limited to the two-layer structure including the inner layer 81a or 82a and the outer layer 81b or 82b, and may have a structure including three or more layers.

### Porosity of Outer Layer Portion

Providing pores P in the outer layer portions 7 allows for relaxing mechanical and thermal stresses that the multilayer ceramic capacitor 1 receives from a wiring board on which the multilayer ceramic capacitor 1 is mounted.

On the other hand, the formation of the pores P raises the likelihood of infiltration of external moisture into the inner layer portion 6 and thus may lead to a decrease in moisture resistance of the multilayer body 2. As such, it is necessary to adjust the porosity.

An LT cross section in a central portion in the width direction W of the multilayer ceramic capacitor 1 is observed using a scanning electron microscope (SEM) at a magnification of about 6,000 times.

A region corresponding to a field of view having a size of about 19.5 μm×about 10.5 μm is photographed at five positions that do not overlap with each other. The obtained SEM images are subjected to image analysis, and a ratio of the area occupied by pores P with respect to the entire field of view is calculated as a porosity. An average value of the porosities of the fields of view at the five positions is obtained.

One of the two outer layer portions 7a and 7b sandwiching the inner layer portion 6 is divided into the following three equal or substantially equal layers in the lamination direction T: an outermost layer 70 located adjacent to the main surface A and having a porosity S1, an intermediate layer 7m having a porosity S2, and an innermost layer 7i located adjacent to the inner layer portion 6 and having a porosity S3. In a case where the porosities S1, S2, and S3 satisfy the following relational expression (1), it is possible to relax the mechanical and thermal stresses while maintaining moisture resistance.

S1>S2>S3 (1)

For example, as illustrated in FIG. 2, in a case where the outer layer portion 7b is divided into three equal or substantially equal layers in the lamination direction T, it is preferable that the porosity S1 of the outermost layer 7bo is relatively large because the pores P in the outermost layer 7bo adjacent to the main surface A contribute to relaxation of the stresses, and that the porosity S3 of the innermost layer 7bi is relatively small because the pores P in the innermost layer 7bi adjacent to the inner layer portion 6 contribute to the moisture resistance. A configuration in which the porosity S1 of the outermost layer 7bo adjacent to the main surface A, the porosity S2 of the intermediate layer 7bm, and the porosity S3 of the innermost layer 7bi adjacent to the inner layer portion 6 satisfy the above relational expression (1) makes it possible to achieve both relaxation of the stresses and maintenance of moisture resistance.

In a case where the two outer layer portions 7a and 7b sandwiching the inner layer portion 6 both satisfy the relational expression (1), the advantageous effects of relaxing the stresses can be reliably achieved.

For example, the porosity S1 of the outermost layer 7bo is preferably about 10% or less, the porosity S2 of the intermediate layer 7bm is preferably about 5% or less, and the porosity S3 of the innermost layer 7bi is preferably about 4% or less.

### Components of Outer Layer Portion

Blending Si in the outer layer portions 7 increases a degree of sintering of the ceramic material, thus reducing a difference in shrinkage ratio between the inner layer portion 6 and the outer layer portions 7 to a low level.

As a result, it is possible to prevent the outer layer portions 7 from peeling off from the inner layer portion 6.

Furthermore, segregation of Si at the interface between the inner layer portion 6 and the outer layer portions 7 can increase the fixation force between the inner layer portion 6 and the outer layer portions 7.

As a result, it is possible to reliably prevent infiltration of external moisture.

In addition, for example, blending Mg can reduce or prevent grain growth of ceramic grains, thus making it possible to form a dense layer structure.

The composition of each component can be determined by performing an elemental analysis by way of wavelength-dispersive x-ray spectroscopy (WDX) transmission electron microscopy-energy dispersive x-ray spectroscopy (TEM-EDX) on a cross section of the multilayer ceramic capacitor at which the dielectric ceramic layers are exposed.

In this measurement, the composition of the dielectric ceramic layers is measured at five points, and an average value is calculated.

The content of Si segregated at the boundary between the inner layer portion 6 and the outer layer portions 7 is preferably higher than the content of Si in the intermediate layers 7m of the outer layer portions 7.

Due to such a high Si content at the boundary, the outer layer portions 7 can be prevented from peeling off from the inner layer portion 6.

The content of Mg segregated at the boundary between the inner layer portion 6 and the outer layer portions 7 is preferably higher than the content of Mg in the intermediate layers 7m of the outer layer portions 7.

In that case, the denseness of the innermost layer 7bi can be increased, thereby improving the moisture resistance.

### Thickness of Outer Layer Portion

The thickness in the lamination direction T of one of the two outer layer portions 7a and 7b is defined as t1, and the thickness in the lamination direction T of the other is defined as t2. In a case where t1 is greater than t2 and the multilayer ceramic capacitor is mounted such that the outer layer portion 7 having the thickness t1 faces a wiring board, vibration sound (acoustic noise) of the wiring board caused by an electrostrictive effect of the multilayer ceramic capacitor can be reduced.

### External Electrode

The external electrodes 3 are electrically connected to the internal electrode layers 5 and function as external input/output terminals.

The external electrodes 3 include a first external electrode 3a and a second external electrode 3b provided on the surfaces of the multilayer body 2.

The first external electrode 3a is provided on the first end surface C1 of the multilayer body 2.

The first external electrode 3a has a cap shape, and an edge portion thereof extends from the first end surface C1 onto the first main surface A1, the second main surface A2, the first side surface B1, and the second side surface B2 of the multilayer body 2.

The second external electrode 3b is provided on the second end surface C2 of the multilayer body 2.

The second external electrode 3b has a cap shape, and an edge portion thereof extends from the second end surface C2 onto the first main surface A1, the second main surface A2, the first side surface B1, and the second side surface B2 of the multilayer body 2.

In the multilayer ceramic capacitor 1, the first internal electrode layers 5a extending toward the first end surface C1 of the multilayer body 2 are connected to the first external electrode 3a.

The second internal electrode layers 5b extending toward the second end surface C2 of the multilayer body 2 are connected to the second external electrode 3b.

Each external electrode 3 may have, for example, a structure including a base electrode layer 30 and a plating layer 31 disposed on the base electrode layer 30.

The base electrode layer 30 includes at least one layer selected from a baked layer, a conductive resin layer, a direct plating layer, or the like, as will be described below.

### Baked Layer

The baked layer is formed by baking a conductive paste including glass and a metal and applied to the multilayer body 2, and may be baked concurrently with firing of the internal electrode layers 5, or may be baked after firing of the internal electrode layers 5.

The baking is, for example, preferably performed at a temperature of about 700° C. to about 900° C.

The glass component includes at least one of, for example, B, Si, Ba, Mg, Al, Li, or the like.

The metal includes, for example, at least one of Cu, Ni, Ag, Pd, a Ag—Pd alloy, Au, or the like.

Preferably, the baked layer has a thickness of about 0.1 μm or more and about 200 μm or less, for example.

The baked layer may include a plurality of layers.

### Conductive Resin Layer

The conductive resin layer is provided on the surface of the baked layer or directly on the surface of the multilayer body 2.

The conductive resin layer may include a plurality of layers.

An example of a method of forming the conductive resin layer includes applying a conductive resin paste including a thermosetting resin and a metal component to the baked layer or the multilayer body 2, and performing a heat treatment at a temperature of about 250° C. to about 550° C. or higher to thermally cure the resin, thereby forming the conductive resin layer.

The heat treatment is preferably performed in a N2 atmosphere, for example.

Furthermore, the oxygen concentration is preferably reduced to, for example, about 100 ppm or less in order to prevent scattering of the resin and oxidation of various metal components.

Preferably, the conductive resin layers have, at the center of the first end surface C1 and at the center of the second end surface C2, a thickness of about 10 μm or more and about 200 μm or less, for example.

On the first main surface A1, the second main surface A2, the first side surface B1, and the second side surface B2, the conductive resin layers preferably have, at its center in the length direction L, a thickness of about 5 μm or more and about 50 μm or less, for example.

Examples of the resin forming the conductive resin layer include various known thermosetting resins such as an epoxy resin, phenol resin, urethane resin, silicone resin, polyimide resin, or the like.

Among them, epoxy resin is one of the more suitable resins because it is excellent in heat resistance, moisture resistance, adhesiveness, etc.

Preferably, the resin is included in the conductive resin layer in an amount of, for example, about 25 vol % or more and about 65 vol % or less with respect to the total volume of the conductive resin.

The conductive resin layer preferably includes a curing agent in addition to the thermosetting resin.

In a case where epoxy resin is used as the base resin, various known compounds such as, for example, a phenol-based compound, an amine-based compound, an acid anhydride-based compound, an imidazole-based compound, or the like can be used as the curing agent.

Due to including the thermosetting resin, the conductive resin layer is more flexible than, for example, a plating film and a conductive layer formed by firing a conductive paste.

For this reason, when a physical impact or an impact due to a thermal cycle is applied to the ceramic electronic component, the conductive resin layer defines and functions as a buffer layer, and cracking of the ceramic electronic component can be prevented.

Metal powder of Ag, Cu, Ni, or an alloy thereof, for example, can be included in the conductive resin layer.

Cu metal powder or Ni metal powder having a surface coated with Ag can be used, for example.

Cu metal powder having a surface treated with an antioxidant can also be used, for example.

Ag metal powder is used as the conductive metal because Ag is suitable for an electrode material due to having a lowest specific resistance among metals, and is a noble metal that is not oxidized and has a high corrosion resistance.

The reason why the Ag-coated metal is preferably used is that an inexpensive metal can be used as the base material while maintaining the above-described characteristics of Ag.

Preferably, the metal powder is included in the conductive resin layer in an amount of, for example, about 35 vol % or more and about 75 vol % or less with respect to the total volume of the conductive resin.

The metal powder included in the conductive resin layer may have any shape without particular limitation.

The metal powder may have a spherical shape, a flat shape, or the like.

The metal powder included in the conductive resin layer may have an average particle diameter of, for example, about 0.3 μm or more and about 10 μm or less, without being limited to this range.

The metal powder included in the conductive resin layer is mainly responsible for the electrical conductivity of the conductive resin layer.

Specifically, the particles of the metal powder in contact with each other provide conduction paths in the conductive resin layer.

### Plating Layer

The plating layer may be directly provided on the end surface C of the multilayer body 2 where the internal electrode layers 5 are exposed.

In other words, the multilayer ceramic capacitor 1 may have a structure including the plating layer electrically directly connected to the internal electrode layers 5 and a surface electrode 32.

In such a case, following a pretreatment of providing a catalyst on a surface of multilayer body 2, the plating layer may be directly provided on the surface of multilayer body 2.

The plating layer preferably includes, for example, at least one metal of Cu, Ni, Sn, Pb, Au, Ag, Pd, Bi, Zn, or an alloy including these metals.

For example, in a case where the first internal electrode layers 5a and the second internal electrode layers 5b include Ni, the direct plating layer preferably includes Cu, which has a good adhesiveness to Ni.

Preferably, the thickness per plating layer is, for example, about 1.0 μm or greater and about 15 μm or less.

The plating layer is preferably free of glass.

The plating layer preferably includes a metal per unit volume at a proportion of, for example, about 99 vol % or more.

The plating process may be performed by either electrolytic plating or electroless plating. However, the electroless plating disadvantageously involves a complicated process because it requires a pretreatment using a catalyst or the like in order to increase the plating deposition rate.

For this reason, electrolytic plating is typically preferred.

As the plating method, for example, barrel plating is preferably used.

If necessary, an upper plating electrode may be provided on a surface of a lower plating electrode in a similar manner.

The plating layer 31 disposed on the base electrode layer 30 includes, for example, at least one of Cu, Ni, Ag, Pd, a Ag—Pd alloy, Au, or the like.

The plating layer may include a plurality of layers, and preferably has a two-layer structure including a Ni plating layer and a Sn plating layer, for example.

The Ni plating layer is capable of preventing the base electrode layer from being eroded by solder when the ceramic electronic component is mounted. The Sn plating layer is capable of improving solder wettability when the ceramic electronic component is mounted, thereby facilitating the mounting.

The thickness per one plating layer is, for example, preferably about 1.0 μm or more and about 15 μm or less.

### Surface Electrode

The surface electrode 32 can be provided on the main surface A of the multilayer body 2 so that the surface electrode 32 extends in a predetermined length from the end surface C of the multilayer body 2 toward the center of the multilayer body 2 in the length direction L.

The surface electrode 32 can be defined by a portion of the external electrode 3 extending onto the main surface A in such a manner that the surface electrode 32 and the external electrode 3 are integrated with each other. Alternatively, as illustrated in FIG. 2, the surface electrode 32 may be provided on the main surface A of the multilayer body 2, and thereafter, may be covered with a portion of the external electrode 3 extending onto the main surface A.

The pores P in the outermost layer 70 included in the outer layer portion 7 and adjacent to the main surface A make the main surface A uneven, such that the contact area increases and the adhesion of the surface electrode 32 can be increased.

Although FIG. 2 illustrates a configuration in which the surface electrode 32 is entirely or substantially entirely covered with the external electrode 3, a configuration in which the surface electrode 32 is at least partially covered with a portion of the external electrode 3 extending onto the main surface A may be provided.

### Method of Manufacturing Multilayer Ceramic Capacitor

Next, an example of a method of manufacturing the multilayer ceramic capacitor 1 according to the present example embodiment will be described.

### Step of Producing Multilayer Body

In a step of producing the multilayer body, first, an inner layer portion-forming ceramic slurry is prepared by adding a solvent and other components to a ceramic material for forming the dielectric layers to be provided in the inner layer portion.

Then, the inner layer portion-forming ceramic slurry is molded into a sheet shape, thus preparing inner layer portion-forming ceramic green sheets for lamination.

A conductive paste is printed in a pattern of the internal electrode layer on a surface of each of the inner layer portion-forming ceramic green sheets for lamination.

Next, the inner layer portion-forming ceramic green sheets for lamination are laminated together and subjected to isostatic pressing, for example, thus producing a block for inner layer portion.

An outer layer portion-forming ceramic slurry is prepared by adding a solvent and other components to a ceramic material for forming the dielectric layers to be provided in the outer layer portions.

Then, the outer layer portion-forming ceramic slurry is molded into a sheet shape, thus preparing outer layer portion-forming ceramic green sheets for lamination.

Next, two sets s of the outer layer portion-forming ceramic green sheets for lamination are laminated and subjected to isostatic pressing, thus preparing a first block for outer layer portion and a second block for outer layer portion.

Since the first block for outer layer portion and the second block for outer layer portion are pressed independently of each other, they have increased denseness as compared with a block subjected to ordinary integral pressing.

Furthermore, in each of the blocks, a portion including the green sheets laminated at the beginning of the laminating process receives a higher pressure and becomes highly dense, whereas a portion including the green sheets laminated at the end of the laminating process becomes less dense than the region including the green sheets laminated at the beginning of the laminating process.

The first block for outer layer portion and the second block for outer layer portion, which have been subjected to the isostatic pressing independently of each other, are placed such that its portion including the densely laminated sheets is positioned adjacent to the inner layer portion. As a result, a structure is achieved in which regions adjacent to the inner layer portion are highly dense.

In this process, the surface electrodes are formed before the isostatic pressing of the first block for outer layer portion and the second block for outer layer portion, such that a conventional step of cutting one dielectric sheet in order to expose the surfaces electrode becomes unnecessary. As a result, it possible to provide the surface electrodes having the same or similar surface shape on the first main surface and the second main surface.

Thereafter, the first block for outer layer portion, the block for inner layer portion, and the second block for outer layer portion are, for example, placed on top of the other and pressed under conditions of a pressing pressure of about 1 MPa to about 50 MPa, a pressing temperature of about 70° C. to about 90° C., and a holding time of about 180 seconds or less at a maximum pressing pressure.

As a result, a mother block member is completed.

The mother block member is cut along cutting lines corresponding to the dimensions of the multilayer body, thus producing a plurality of multilayer chips.

The multilayer chips are barrel-polished so that the corner portions and ridge portions are rounded, and then fired.

According to the above-described steps, the outer layer portions 7 and the side gap portions 8 can be formed concurrently with the production of the multilayer body 2. Alternatively, the multilayer body 2 may be produced in a manner in which the mother block member is cut into inner layer portions 6 each including opposite side surfaces at which the ends of the internal electrode layers 5 in the width direction W are exposed, and then, a ceramic material is attached to the opposite side surfaces of the inner layer portion 6 so as to cover the exposed ends of the internal electrode layers 5.

The multilayer body 2 produced in this manner includes the side gap portions 81 and 82 illustrated in FIG. 5.

### Firing Step

In a firing step, the multilayer chips are subjected to a binder removal treatment and firing, thus producing base bodies.

The conductive paste layers and dielectric layer-forming green sheets are co-sintered in the firing, and turn into the internal electrode layers 5 and the dielectric layers 4, respectively.

It is simply required to determine the condition of the binder removal treatment in accordance with the type of the organic binder included in the green sheets and the conductive paste layers.

It is simply required to perform the firing at a temperature at which the multilayer chips are sufficiently densified.

The firing temperature is, for example, preferably about 900° C. to about 1400° C., although it depends on the dielectric and materials of the internal electrode layers.

### External Electrode Forming Step

In an external electrode forming step, the external electrodes 3 are formed on the multilayer body 2, thus completing the multilayer ceramic capacitor 1.

The external electrodes 3 are suitably formed by a known method.

For example, a base electrode layer, a conductive resin layer, or a direct plating layer is formed on the end surfaces C of the multilayer body 2 to which the internal electrode layers 5 extend and are exposed, and a plating layer is further provided as necessary.

In the present example embodiment, for example, a Ni plating layer and a Sn plating layer are formed over the baked layer.

The Ni plating layer and the Sn plating layer are sequentially formed by barrel plating, for example.

Thus, the multilayer ceramic capacitor can be obtained.

### Second Example Embodiment

A multilayer ceramic capacitor 100 according to a second example embodiment of the present invention will be described below.

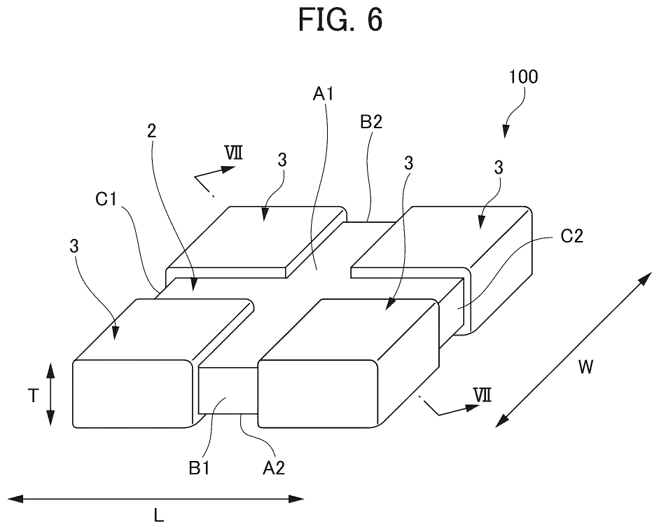

FIGS. 6 to 8 illustrate the shape and structure of the multilayer ceramic capacitor 100.

FIG. 6 is a schematic perspective view of the multilayer ceramic capacitor 100.

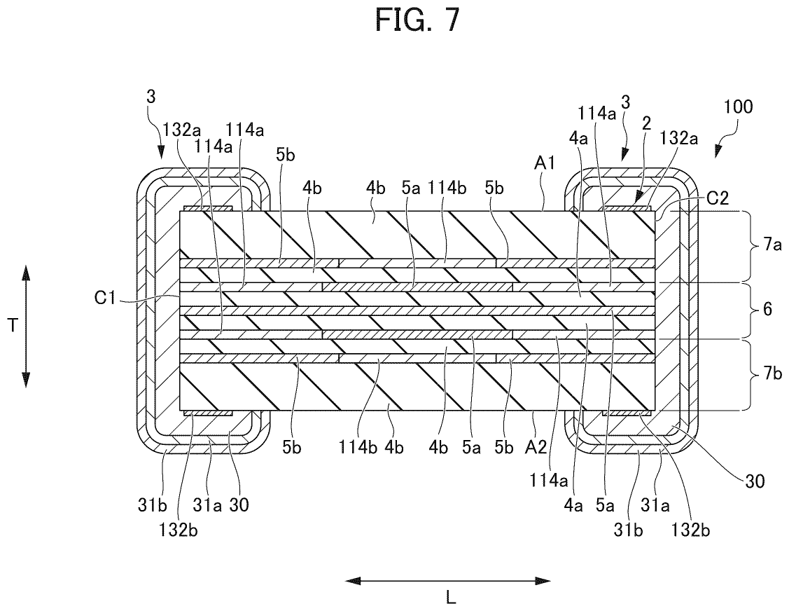

FIG. 7 is a cross-sectional view of the multilayer ceramic capacitor 100 taken along line VII-VII shown in FIG. 6.

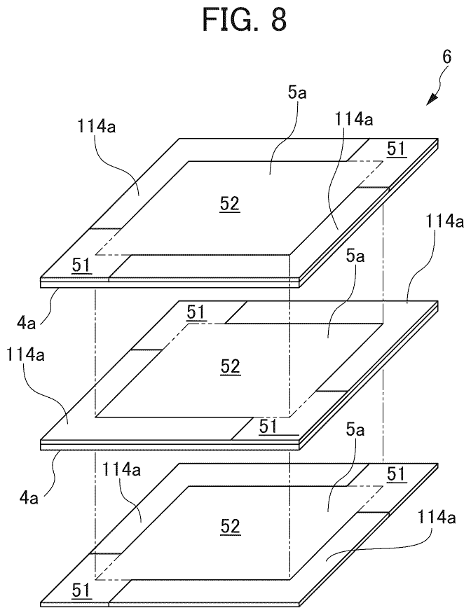

FIG. 8 is a schematic view illustrating a structure of an inner layer portion 6 of the multilayer ceramic capacitor 100.

In the following description of the multilayer ceramic capacitor 100, features different from those of the multilayer ceramic capacitor 1 of the first example embodiment will be mainly described.

Referring to FIG. 6, the multilayer ceramic capacitor 100 of the present example embodiment includes a multilayer body 2 and four external electrodes 3.

The external electrodes 3 are respectively disposed at four corner portions of the multilayer body 2 as viewed along the lamination direction T.

Each external electrode 3 is disposed to cover a portion of the first main surface A1, a portion of the second main surface A2, a portion of the first side surface B1 or the second side surface B2, and a portion of the first end surface C1 or the second end surface C2 of the multilayer body 2. However, this is a non-limiting example, and each external electrode 3 may be disposed such that a portion of the first main surface A1 or a portion of the second main surface A2 is not covered in order to further reduce the dimension in the lamination direction T.

In the latter case, each external electrode has an L-shape or substantially L-shape.

The multilayer ceramic capacitor 100 of the present example embodiment has a configuration in which a ratio Y/X of a length Y in the width direction W to a length X in the length direction L is, for example, about 0.85 or more and about 1.0 or less, without being limited thereto.

For example, when the ratio Y/X of the length Y to the length X is smaller than about 0.85, the shape is close to a rectangular or substantially rectangular shape rather than a square or substantially square shape.

In this case, the height of the multilayer ceramic capacitor 100, that is, the dimension in the lamination direction T is, for example, preferably about 120 μm or less.

Referring to FIGS. 7 and 8, first internal electrode layers 5a of the present example embodiment each include a counter electrode portion 52 and two extension electrode portions 51.

Each extension electrode portion 51 is exposed at the first side surface B1 or the second side surface B2 and the first end surface C1 or the second end surface C2.

Regarding two first internal electrode layers 5a facing each other in the lamination direction T, the extension electrode portions 51 of one of them extend toward two surfaces, and the extension electrode portions 51 of the other extend toward different two surfaces.

Specifically, in a case where one of the two first internal electrode layers 5a has the extension electrode portion 51 extending toward the first side surface B1 and the first end surface C1 and the extension electrode portion 51 extending toward the second side surface B2 and the second end surface C2, the other of the two first internal electrode layers 5a has the extension electrode portion 51 extending toward the first side surface B1 and the second end surface C2 and the extension electrode portion 51 extending toward the second side surface B2 and the first end surface C1.

As illustrated in FIG. 8, each extension electrode portion 51 is continuously exposed at the end surface and the side surface. However, this is a non-limiting example, and each extension electrode portion 51 may be discontinuously exposed at the end surface and the side surface.

Each first internal electrode layer 5a includes dielectric layers 114a provided along the periphery of the counter electrode portion 52, except for portions where the extension electrode portions 51 extend.

Second internal electrode layers 5b are disposed at positions shifted in the lamination direction T from the extension electrode portions 51 of the first internal electrode layers 5a.

In other words, the second internal electrode layers 5b are disposed at positions overlapping with the extension electrode portions 51 of the first internal electrode layers 5a when viewed in the lamination direction T.

Two second internal electrode layers 5b may be disposed on the same plane.

The two second internal electrode layers 5b disposed on the same plane do not overlap with each other when viewed in the lamination direction T, and a dielectric layer 114b is disposed between the two second internal electrode layers 5b.

Two outer layer portions 7a and 7b each include one second internal electrode layer 5b disposed therein, thus making it possible to ensure an electrical junction between first surface electrodes 132a (to be described later), second surface electrodes 132b (to be described later), and the first internal electrode layers 5a via a base electrode layer 30.

In addition, since a conductive component of the second internal electrode layers 5b and a conductive component in the external electrode 3 are fixed to each other, it is possible to improve a fixation force between the multilayer body 2 and the external electrodes 3.

Referring to FIG. 7, in the present example embodiment, four first surface electrodes 132a (only two are shown in FIG. 7) are disposed on the first main surface A1 of the multilayer body 2.

Four second surface electrodes 132b (only two are shown in FIG. 7) are disposed on the second main surface A2 of the multilayer body 2.

The first surface electrodes 132a are disposed on the four corner portions of the first main surface A1, respectively.

The second surface electrodes 132b are disposed on the four corner portions of the second main surface A2, respectively.

The first surface electrodes 132a and the second surface electrodes 132b are disposed at positions shifted in the lamination direction T from the extension electrode portions 51 of the first internal electrode layers 5a.

In other words, the first surface electrodes 132a and the second surface electrodes 132b are disposed at positions overlapping with the extension electrode portions 51 of the first internal electrode layers 5a when viewed in the lamination direction T.

The first surface electrodes 132a and the second surface electrodes 132b do not generate capacitance.

The first surface electrodes 132a and the second surface electrodes 132b may have the same or substantially the same shape and dimensions as those of the second internal electrode layer 5b.

In that case, the first surface electrodes 132a and the second surface electrodes 132b are preferably made of the same material as that of the second internal electrode layer 5b.

The first surface electrodes 132a and the second surface electrodes 132b may be formed by sputtering, for example.

In the case where the first surface electrodes 132a and the second surface electrodes 132b are formed by sputtering, the first surface electrodes 132a and the second surface electrodes 132b preferably include, for example, at least one of Ni, Cr, Cu, or Ti.

Preferably, the first surface electrodes 132a and the second surface electrodes 132b formed by sputtering have a thickens of, for example, about 50 nm or more and about 400 nm or less.

Due to this configuration, in which the first surface electrodes 132a and the second surface electrodes 132b are made sufficiently thin in the lamination direction T, the thickness of the multilayer ceramic capacitor 100 in the lamination direction T can be sufficiently reduced.

The thicknesses of the first surface electrodes 132a and the second surface electrodes 132b in the lamination direction T can be adjusted by changing the distance between the portion to be sputtered and a target.

The thicknesses of the first surface electrodes 132a and the second surface electrodes 132b may be measured in an actual observation image, or may be determined by conversion from a predetermined element that is identified by a calibration-curve method for metal species using fluorescent X-rays.

The first surface electrodes 132a and the second surface electrodes 132b may be fired electrodes, for example.

The fired electrode is an electrode including a dielectric component of the same type as a component of the dielectric layers 4.

Specifically, in a case where the dielectric layers 4 include CaZrO₃, the first surface electrodes 132a and the second surface electrodes 132b include, for example, Ca, Zr, or CaZrO₃.

In a case where a dielectric layer 4a and a dielectric layer 4b include different components, the first surface electrodes 132a and the second surface electrodes 132b preferably include the same kind of component as a component in the dielectric layer 4b.

In the latter case, the first surface electrodes 132a and the second surface electrodes 132b can be firmly fixed to the dielectric layers 4b.

The fired electrodes preferably include, for example, Ni as a metal component.

In that case, the first internal electrode layers 5a preferably include, for example, Ni.

Due to the configuration in which the fired electrodes include the same kind of metal component as that of the first internal electrode layers 5a, the first surface electrodes 132a and the second surface electrodes 132b can be fired concurrently with the firing of the multilayer body 2.

The fired electrode is formed by firing a Ni fired electrode-forming conductive paste printed on dielectric sheets by screen printing or the like, for example.

The Ni fired electrode-forming conductive paste is applied in a small thickness or the Ni fired electrode-forming conductive paste is prepared so as to include a small amount of a dielectric component, such that Ni grains join each other at the time of firing, and the fired electrodes are formed in a discontinuous shape.

The fired electrode formed in a discontinuous shape means that the fired electrode is discontinuous when viewed in the width direction W.

As illustrated in FIG. 7, each external electrode 3 includes the base electrode layer 30 including a conductive metal and disposed on the multilayer body 2, a lower plating layer 31a disposed so as to cover a surface of the base electrode layer 30, and a surface plating layer 31b disposed so as to cover a surface of the lower plating layer 31a.

In the present example embodiment, for example, the lower plating layer 31a is a Ni plating layer, and the surface plating layer 31b is a Sn plating layer.

Although FIG. 7 illustrates that the base electrode layer 30, the lower plating layer 31a, and the surface plating layer 31b are disposed in this order, an arrangement in which the base electrode layer, the surface plating layer, the lower plating layer, and the surface plating layer are disposed may be provided.

The base electrode layers 30 are preferably direct plating layers.

The direct plating layer is a plating layer that directly covers a surface of the multilayer body 2.

Providing each base electrode layer 30 by the direct plating layer makes the external electrode 3 thin in each direction, thus making it possible to reduce the size of the multilayer ceramic capacitor.

The direct plating layer preferably includes a metal per unit volume at a proportion of, for example, about 99 vol % or more.

The direct plating layer may include two plating layers having different metal particle sizes.

In that case, it is preferable that the plating layer having a large metal particle diameter is disposed adjacent to the multilayer body 2, and the plating layer having a small metal particle diameter is spaced away from the multilayer body 2.

The multilayer ceramic capacitor 100 according to the second example embodiment exerts the same or substantially the same advantageous effects as those of the multilayer ceramic capacitor 1 according to the first example embodiment.

### Third Example Embodiment

A multilayer ceramic capacitor 200 according to a third example embodiment of the present invention will be described below.

In the following description of the multilayer ceramic capacitor 200, features different from those of the multilayer ceramic capacitor 1 according to the first example embodiment and the multilayer ceramic capacitor 100 according to the second example embodiment will be mainly described.

The multilayer ceramic capacitor 200 according to the third example embodiment has the same or substantially the same configuration as that of the multilayer ceramic capacitor 100 according to the second example embodiment except for the overall shape.

In the description of the third example embodiment, components that are the same as or similar to those of the second example embodiment are denoted by the same or similar reference signs, and detailed description thereof will be omitted.

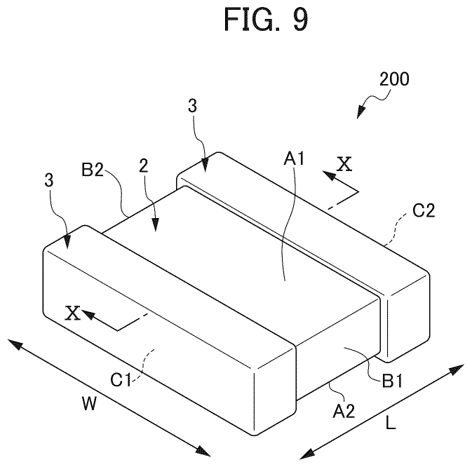

FIG. 9 is a perspective view of the multilayer ceramic capacitor 200 according to the present example embodiment.

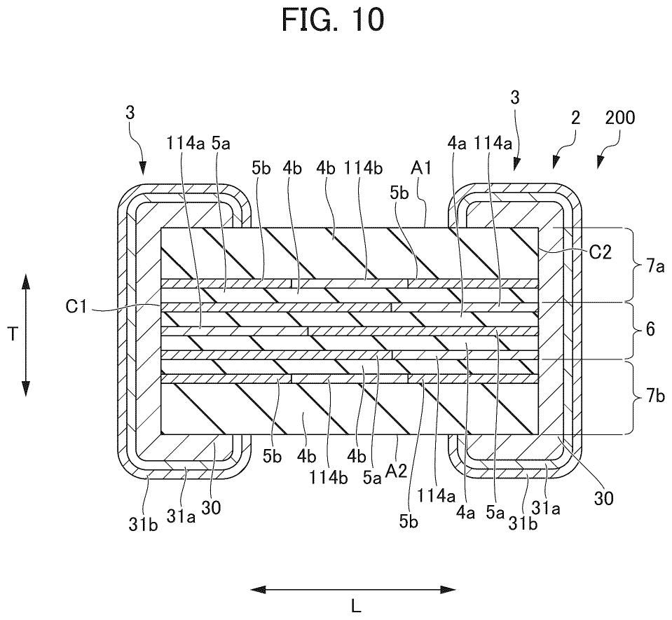

FIG. 10 is a cross-sectional view taken along line X-X in FIG. 9.

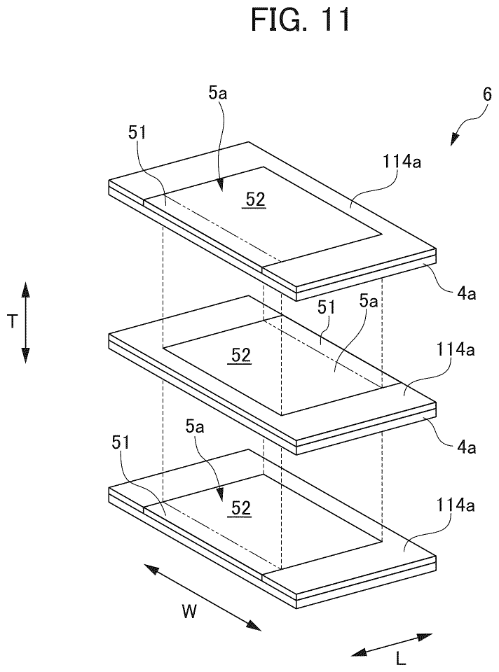

FIG. 11 is an exploded perspective view of an inner layer portion 6 according to the present example embodiment.

Referring to FIG. 9, the multilayer ceramic capacitor 200 of the present example embodiment has a shorter length in the length direction L than in the width direction W.

Referring to FIGS. 10 and 11, each first internal electrode layer 5a is exposed at the first end surface C1 or the second end surface C2. However, this is a non-limiting example, and each first internal electrode layer 5a may be exposed at the first end surface C1 or the second end surface C2 and both of the first side surface B1 and the second side surface B2.

It should be noted that the present invention is not limited to the example embodiments described above, and can be provided in various modes without deviating from the scope and spirit of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion and two outer layer portions, the inner layer portion including dielectric layers and internal electrode layers laminated in a lamination direction, the two outer layer portions sandwiching the inner layer portion in the lamination direction and defining two main surfaces at positions opposite to each other in the lamination direction; and
an external electrode on each of end surfaces of the multilayer body opposite to each other in a length direction intersecting with the lamination direction, the external electrode being connected to the internal electrode layers; wherein
where one of the two outer layer portions sandwiching the inner layer portion is divided, in the lamination direction, into three equal or substantially equal layers including an outermost layer located adjacent to the main surface and having a porosity S1, an intermediate layer having a porosity S2, and an innermost layer located adjacent to the inner layer portion and having a porosity S3, the porosities S1, S2, and S3 satisfy S1>S2>S3.

2. The multilayer ceramic capacitor according to claim 1, wherein the two outer layer portions sandwiching the inner layer portion both satisfy S1>S2>S3.

3. The multilayer ceramic capacitor according to claim 1, wherein the porosity S1 of the outermost layer is about 10% or less.

4. The multilayer ceramic capacitor according to claim 1, wherein the porosity S2 of the intermediate layer is about 5% or less.

5. The multilayer ceramic capacitor according to claim 1, wherein the porosity S3 of the innermost layer is about 4% or less.

6. The multilayer ceramic capacitor according to claim 1, wherein a content of Si in a boundary between the outer layer portion and the inner layer portion is higher than a content of Si in the intermediate layer of the outer layer portion.

7. The multilayer ceramic capacitor according to claim 1, wherein a content of Mg in a boundary between the outer layer portion and the inner layer portion is higher than a content of Mg in the intermediate layer of the outer layer portion.

8. The multilayer ceramic capacitor according to claim 1, further comprising a surface electrode on the main surface.

9. The multilayer ceramic capacitor according to claim 8, wherein the surface electrode is at least partially covered with a portion of the external electrode extending onto the main surface.

10. The multilayer ceramic capacitor according to claim 9, further comprising a plating layer directly connected to the internal electrode layers and the surface electrode.

11. The multilayer ceramic capacitor according to claim 1, wherein a ratio Y/X of a dimension Y in the width direction to a dimension X in the length direction is about 0.85 or more and about 1.0 or less.

12. The multilayer ceramic capacitor according to claim 2, wherein a ratio Y/X of a dimension Y in the width direction to a dimension X in the length direction is about 0.85 or more and about 1.0 or less.

13. The multilayer ceramic capacitor according to claim 11, wherein
the internal electrode layers include first internal electrode layers and second internal electrode layers;
the first internal electrode layers include a counter electrode portion and two extension electrode portions; and
the second internal electrode layers are disposed at positions shifted in the lamination direction from the extension electrode portions of the first internal electrode layers.

14. The multilayer ceramic capacitor according to claim 11, wherein
the internal electrode layers include first internal electrode layers and second internal electrode layers;
the first internal electrode layers include a counter electrode portion and two extension electrode portions; and
the second internal electrode layers are disposed at positions overlapping with the extension electrode portions of the first internal electrode layers when viewed in the lamination direction.

15. The multilayer ceramic capacitor according to claim 13, wherein the second internal electrode layers are disposed at at least one of the two outer layer portions.

16. The multilayer ceramic capacitor according to claim 14, wherein the second internal electrode layers are disposed at at least one of the two outer layer portions.

17. The multilayer ceramic capacitor according to claim 13, further comprising:
a surface electrode on the main surface; and
the surface electrode has the same or substantially the same shape as that of the second internal electrode layer.

18. The multilayer ceramic capacitor according to claim 14, further comprising:
a surface electrode on the main surface; and
the surface electrode has the same or substantially the same shape as that of the second internal electrode layer.

19. The multilayer ceramic capacitor according to claim 13, further comprising:
a surface electrode on the main surface; and
the surface electrode includes the same main component as that of the second internal electrode layer.

20. The multilayer ceramic capacitor according to claim 14, further comprising:
a surface electrode on the main surface; and
the surface electrode includes the same main component as that of the second internal electrode layer.
